(19) United States
(12) Patent Application Publication
(10) Pub. No.: US 2018/0029758 A1
(43) Pub. Date: Feb. 1, 2018

(54) SEALING DEVICE FOR A CONTAINER FOR ASEPTICALLY RECEIVING A FLOWABLE PRODUCT AND CONTAINER AND METHOD FOR ASEPTIC FILLING

(71) Applicant: Henno Hensen, Bremen (DE)

(72) Inventors: Henno Hensen, Bremen (DE); Adam Green, Gloucestershire (GB)

(21) Appl. No.: 15/524,814

(22) PCT Filed: Oct. 30, 2015
(86) PCT No.: PCT/EP2015/075227

§ 371 Date: Sep. 28, 2017

(30) Foreign Application Priority Data
Nov. 6, 2014 (DE) 10 2014 116 151.3

(51) Int. Cl. B65D 47/12; B67C 7/00; B65D 41/34; B67C 3/26

(52) U.S. Cl. CPC B65D 47/122; B67C 3/2642; B67C 7/0073; B67C 7/0006; B65D 41/3442; B67C 2003/228

(57) ABSTRACT

A closure device for a container for aseptically receiving a flowable product has a spout with a product filling duct extending axially between a first end and a second end. The closure device has a closure cap which can be mounted onto the spout. In the mounted state, the cap closes the second end of the product filling duct. The closure cap is connectable in axially positively locking fashion to the spout in two axially different positions. The first position is a position in which the closure cap is not fully mounted on the spout, and the second position is a position in which the closure cap is fully mounted on the spout. The closure cap can bear sealingly against the spout in the first position and in the second position to optimize sterility during the filling process.

### CROSS-REFERENCE TO RELATED APPLICATIONS

This application is a national stage application under 35 U.S.C. 371 of International Patent Application Serial No. PCT/EP2015/075227, entitled “SEALING DEVICE FOR A CONTAINER FOR ASEPTICALLY RECEIVING A FLOWABLE PRODUCT AND CONTAINER AND METHOD FOR ASEPTIC FILING,” filed Oct. 30, 2015, which claims priority from German Patent Application No. DE 10 2014 116 151.3, filed Nov. 6, 2014, the disclosure of which is incorporated herein by reference.

### BACKGROUND

In the foodstuffs sector in particular, or in the medical sector, sterility is of particularly high importance. Therefore, during the production and in particular also during the filling of the container, it is necessary to ensure an aseptic (sterile) environment. In particular, it is necessary for all elements which come into contact with the container during the filling process, and the container itself, to be sterile.

To achieve receipt of a flowable product in aseptic fashion, it is known for example from DE 10 2010 049 263 A1 for a stand-up pouch equipped with a spout to be introduced into a filling chamber, wherein the spout and pouch have been sterilized beforehand. The sterilization from the inside is generally realized by charging with a gaseous and/or vaporous sterilization agent. Further sterilization of the entire container is realized by irradiation with gamma, beta, electron and/or microwave radiation. The sterilization is performed with the spout closed, wherein, in this case, the spout is firmly sealed at its upper opening. In the filling chamber, the sealed region of the spout is cut off, and the product filling duct is thus opened up. Subsequently, the pouch is filled with the product by means of a filling head, which is arranged above the spout and out of which the product is conducted into the pouch via the spout. After the end of the filling process, the pouch is closed off in hermetically sealed fashion by virtue of a closure being mounted onto the spout. Furthermore, while the pouch is situated in the filling chamber, in order to ensure as high a level of sterility as possible, the pouch and spout are irradiated from above by means of ultraviolet radiation (UV radiation).

It is likewise the case in the prior art described in DE 3 301 315 C2 that sterilization of a container to be filled, including the spout equipped with a closure cap, is realized by irradiation with UV radiation from above. It is sought to ensure the sterility of the filling apparatus by virtue of the filling head being sprayed with disinfectant liquid.

From U.S. Pat. No. 5,129,212, it is likewise known, for the aseptic filling of a container, for the container, spout and closure cap to be laterally irradiated with UV radiation. For this purpose, the container equipped with spout and closure cap is led through an elongate tunnel in which the filling chamber is situated, the tunnel walls of which are equipped with UV tubes running in the longitudinal direction, which UV tubes ensure lateral irradiation. The tunnel is additionally also filled with sterile gas.

DE 3 108 173 C2 describes a container with a two-part spout, wherein the first spout part is fixedly connected to the rest of the container, and the second spout part is plugged together with the first spout part after the filling process. Here, the second spout part may also have a tubular mouthpiece. In the case of this prior art, the sterilization is performed by spraying all of the components of the filling apparatus with a disinfectant liquid.

From DE 2 919 388 A1, it is furthermore known for the filling chamber to be charged with a sterile pressurized gas at positive pressure, wherein, in order to ensure that a flowable product is received in aseptic fashion, the spout and the pouch interior are also brought into contact with the sterile gas.

From internal prior art, it is also known for a container body in the form of a pouch not yet equipped with a spout to be provided, for said pouch to be sterilized, and for said pouch to be filled with the product, through a pouch opening at the upper pouch end, in a filling station, for a closure device composed of a spout and of a closure cap mounted onto the spout to be inserted, after the filling process, into the pouch opening through which the pouch was previously filled, and for the spout to be welded to the pouch. The closure device composed of the spout and closure cap is provided, and connected to the filled pouch, in a state in which the closure cap is situated in a fully mounted (screwed-on) position on the spout. Said position will hereinafter always be referred to as “second position”. The pouch (the entire unit composed of pouch and closure device) is thus fully closed after the spout of the closure device has been welded to the pouch within the pouch opening through which the product was previously introduced.

### SUMMARY

The present disclosure relates to a closure device for a container for aseptically receiving a flowable product, in particular for a pouch pack, having a spout which has a product filling duct extending axially between a first end and a second end, wherein the first end forms the container-side end of the spout and the second end forms the closure-side end of the spout, having a closure cap which can be mounted onto the spout and which, in the mounted state, closes the second end of the product filling duct, wherein the closure cap is connectable in axially positively locking fashion to the spout in two axially different positions, wherein the first position of the two axially different positions is a position in which the closure cap is not fully mounted on the spout, and wherein the second position of the two axially different positions is a position in which the closure cap is fully mounted on the spout. The disclosure also relates to a container for aseptically receiving a flowable product, having a container body and having a spout connected to the container body.

Finally, the disclosure relates to a method for the aseptic filling of a container, in which method a previously sterilized container is provided, the interior of a chamber of a filling station, including a filling head of the filling station, is sterilized, the sterilized container is transported into the interior of the chamber, and the container is filled, in the chamber, with the product.

A container which has a spout refers in particular to a pouch pack, for example a stand-up pouch. A pouch pack of said type is produced from a single-layer or multi-layer material which is flexible and which is composed of plastic and/or metal foil. Cans, cartons or bottles, in particular composed of plastic and/or metal and/or coated cardboard, are also containers within the meaning of the disclosure. Containers of said type serve for example for receiving foodstuffs, specifically for receiving beverages and/or baby food, but also other flowable (e.g. liquid or pasty) products.

A problem in the case of the above-described internal prior art is however that, after the filling process, product residues are present in the region of the opening that is to be welded to the spout of the closure device, that is to say in the so-called sealing region. This has the disadvantage that the welded connection between spout and pouch is adversely affected, which in the worst case can lead to a leakage point through which the product can escape or ambient air can penetrate into the pouch interior. From a hygiene aspect too, contamination of the sealing region is undesirable.

It is an object of the present disclosure to specify a spout for a container and a corresponding container and a corresponding method for the aseptic filling of a container, with which the sterility during the filling process is optimized.

The above-derived and stated object is achieved, in accordance with a first teaching of the present disclosure, in the case of a closure device for a container for aseptically receiving a flowable, for example liquid or pasty, product, in particular for a pouch pack, for example for a stand-up pouch, having a spout which has a product filling duct extending axially (that is to say parallel to the axial direction) between a first end and a second end, wherein the first end forms the container-side end (that is to say the lower end) of the spout and the second end forms the closure-side end (that is to say the upper end) of the spout, having a closure cap which can be mounted (over the closure-side end of the spout) onto the spout and which, in the mounted state, closes the second end of the product filling duct, wherein the closure cap is connectable in axially positively locking fashion to the spout in two axially different positions, wherein the first position of the two axially different positions is a position in which the closure cap is not fully mounted on, in particular screwed onto, the spout, and wherein the second position of the two axially different positions is a position in which the closure cap is fully mounted on, in particular screwed onto, the spout, in that the closure cap bears sealingly against the spout in the first position and in the second position.

In the context of the disclosure, the terms “radially” or “axially” always relate to the profile axis or longitudinal axis of the product filling duct.

The spout and/or the closure cap of the closure device is formed in particular in unipartite fashion (integrally, composed of one piece).

Where reference is made to two “axially different positions”, this means that the positions are spaced apart from one another in an axial direction. “In axially positively locking fashion” means that positive locking exists between the parts, that is to say in this case between the closure cap and the spout, counter to the connecting direction, which runs in the axial direction. The latter is realized for example by virtue of an external thread being provided on the spout and a complementary internal thread being provided on the closure cap, or vice versa.

Where it is stated that the closure cap is “fully mounted on the spout”, this means that the closure cap is situated in the intended end position in which a filled pouch equipped with a closure device of said type is shipped to trade outlets and/or to consumers. In this position (second position), the closure cap is situated at an axial stop on the spout and can therefore be mounted or screwed onto the spout no further (at least not to a significant extent). “Not fully mounted on the spout” correspondingly means that the closure cap and spout are connected to one another in axially positively locking fashion, that is to say the threads that may be provided are in engagement with one another, but the closure cap can still be mounted, in particular screwed, onto the spout further until the fully mounted position has been reached.

By virtue of the fact that the closure cap bears sealingly against the spout both in the first position and in the second position, it is made possible for a container equipped with a closure device of said type to be supplied in the sterilized (sterile) state to a filling station and, there, for the closure cap to be removed from the spout particularly easily and without destruction of constituent parts of the closure device—specifically because the closure cap is situated only in the first of the two positions. Thus, it is no longer necessary for the container body, for example in the form of a pouch, to initially be filled without a spout connected thereto and for the spout with fully mounted closure cap to then be welded to the container body or pouch in a subsequent step. In this way, there is no longer the problem of the sealing region being contaminated with product residues during the welding of spout and pouch. In other words, according to the disclosure, it is made possible for an already fully produced container, in the case of which the closure cap is still removable without for example a ring-shaped tamper-evident securing element being destroyed, to be filled.

At the same time, an important criterion of the present disclosure is that, even when the closure cap is situated in the first position and has thus not yet been finally mounted on (screwed onto) the spout, a seal already exists between the closure cap and spout, which seal has the effect that, in the case of a previously sterilized container, germs are prevented from ingressing into the interior of the container during transport into a filling station. “Sealingly” thus means that, under normal ambient conditions, that is to say when no positive pressure prevails outside the container, but rather the pressures in the container interior and outside the container are substantially equal, no exchange occurs between the container interior and the exterior surroundings; the connection between closure cap and spout is thus hermetically sealed in this manner in the first position and in the second position. It is thus not imperatively necessary for the container to be sterilized in the interior of the filling station before the filling process itself starts. Rather, it is possible for the container to be sterilized even in large unit quantities, and in a manner optimized for the purpose, and then transported in the sterile state, with the closure cap situated in the first position, into the filling station or the chamber in which the filling process is performed.

Various refinements of the closure device according to the disclosure will now be described below, which refinements promote the above-described advantageous effects and permit, in a particularly simple manner, the production of a container, in particular a pouch pack, filled with a product.

In one refinement of the closure device according to the disclosure, the closure cap bears sealingly against the closure-side end of the spout in the first position and in the second position. In some embodiments, according to the disclosure, the closure cap bears at the inner side against the second end of the product filling duct in the first and the second position. In this case, the closure cap, or at least a part thereof, thus overlaps an end-side section of the spout or product filling duct in a radial direction.

As discussed above, there is an axial spacing between the first position and the second position, that is to say a spacing in the profile direction of the product filling duct or of the axis of rotation thereof In one refinement, said axial spacing between the two positions amounts to at least 0.5 mm, such as at least 1.0 mm or at least 1.5 mm. Said minimum spacing is required in particular if the closure cap has a ring-shaped tamper-evident securing element at the lower end, which lower end in the mounted state faces toward the container body, and said tamper-evident securing element has to be moved over a radially encircling projection on the spout by moving the closure cap from the first position into the second position in order to bring the tamper-evident securing element into the final position. In said final position, the tamper-evident securing element forms a seal which indicates to the user whether the closure cap has already been opened after the filling of the container, or whether the closure cap remains in its original state (final state after the filling and closure).

Thus, in a further refinement of the closure apparatus according to the disclosure, it is provided that the closure cap has, on its container-side end, a ring-shaped tamper-evident securing element which is connected in unipartite fashion to the rest of the closure cap, for example by means of axial webs which connect the tamper-evident securing element to the rest of the closure cap. On the outside of the spout, there is formed a radially encircling projection whose outer diameter is greater than the inner diameter of a section of the tamper-evident securing element, wherein, in the first position, the section of the tamper-evident securing element is arranged between the closure-side end of the spout and the radially encircling projection in an axial direction, and wherein, in the second position, the section of the tamper-evident securing element is arranged between the radially encircling projection and the container-side end of the spout in the axial direction. The tamper-evident securing element is a ring-shaped element which, during the release (partial or complete removal) of the closure cap from the spout proceeding from the second position, is at least partially detached (torn off) from the rest of the closure cap and/or is destroyed (the ring shape is destroyed).

Before the closure cap is placed into the second position for the first time, in the first position, the tamper-evident securing element is not at least partially detached from the rest of the closure cap and/or is not destroyed. The tamper-evident securing element is then even in particular not deformed at all (in relation to an unloaded state). In order for the closure cap to be moved from the first position into the second position without the tamper-evident securing element being destroyed in the process, the tamper-evident securing element has an encircling bevel (chamfer) on the inner side at the section whose inner diameter is smaller than the outer diameter of the radially encircling projection of the spout, specifically on the side which, in the first position of the closure cap, faces toward the radially encircling projection. On the other side, the section whose inner diameter is smaller than the outer diameter of the radially encircling projection of the spout has no bevel, it rather being the case that, on said side, which thus faces toward the radially encircling projection when the closure cap is in the second position, the section has an encircling abutment surface running substantially perpendicular to the axial direction. This form of said section of the tamper-evident securing element has the effect that, when the closure cap is moved from the first position into the second position, said section is pushed over the radially encircling projection on the spout, wherein said section, owing to its elasticity or the elastic connection to the rest of the closure cap, can (temporarily) deform slightly, whereas, when the closure cap is moved from the second position into the first position, the described abutment surface of said section of the tamper-evident securing element abuts against the underside (the side facing toward the container body) of the radially encircling projection and is prevented from surmounting the radially encircling projection. If the closure cap is moved into the first position, the tamper-evident securing element is, as described, at least partially detached from the rest of the closure cap and/or destroyed.

According to a yet further refinement of the closure device according to the disclosure, the closure cap has, on its axial inner side, that is to say on the surface pointing in the axial direction, a protrusion extending in the axial direction (projecting in the axial direction). In particular, said protrusion is a ring-shaped protrusion extending in the axial direction (projecting in the axial direction). Said protrusion then serves in particular for ensuring the sealing abutment between closure cap and spout. It is thus provided in particular that the protrusion bears sealingly against the spout, such as against the closure-side end of the spout, in particular at the inner side against the second end of the product filling duct, in the first position and in the second position. It is additionally or alternatively provided that the protrusion is connected in non-positively locking fashion to the spout, such as to the closure-side end of the spout, in particular to the inner side at the second end of the product filling duct, in the first position and in the second position.

To ensure a particularly reliable sealing action between closure cap and spout, in the first position, the protrusion overlaps an end-side part of the spout or product filling duct in the radial direction in a range from 1 to 10 mm, such as in a range from 1 to 5 mm, or in a range from 1 to 3 mm. The sealing abutment between protrusion and spout exists at least in a partial region of the overlap, such as in the entire region of the overlap, and extends over the entire circumference of the contact region.

According to a second teaching of the present disclosure, the object is also achieved in the case of a container for aseptically receiving a flowable, for example liquid or pasty, product, having a container body, for example a container body in pouch form, and having a spout connected, for example adhesively bonded or welded, to the container body, in that the container has a closure device as defined above, and the spout is a constituent part of the closure device.

Finally, according to a third teaching of the present disclosure, the object is achieved by means of a method for aseptically filling a container with a product, in which method the following steps, all or some steps can be in succession in the stated sequence, are performed: providing a container as described above, wherein the closure cap is situated in the first position, that is to say the spout is fixedly connected to the container and the closure cap has not been fully mounted on or screwed onto the spout, sterilizing the container while the closure cap remains in the first position, sterilizing the interior of a chamber of a filling station, including a filling head of the filling station, transporting the sterilized container into the interior of the (sterilized) chamber, removing the closure cap in the interior of the (sterilized) chamber, filling the container with the product in the interior of the chamber, mounting the closure cap, wherein the closure cap is placed into the second position, in the interior of the chamber, and transporting the filled and fully closed container out of the chamber.

As has already been discussed above, the stated method steps can be performed with the container according to the disclosure and/or the closure device according to the disclosure in a particularly simple manner, and optimum sterility during the filling process is thereby ensured.

In one refinement of the method according to the disclosure, it is provided that, after the step of the removal of the closure cap in the interior of the chamber and before the step of the filling of the container with the product in the interior of the chamber, the filling head is lowered from an initial position in the direction of the closure-side end of the spout, and in particular, a part of the filling head is lowered into the interior of the product filling duct, and wherein, after the step of the filling of the container with the product in the interior of the chamber and before the step of the mounting of the closure cap in the interior of the chamber, the filling head is moved back into the initial position.

In a yet further refinement of the method according to the disclosure, it is provided that the filling head is sterilized after the step of the filling of the container with the product in the interior of the chamber, in particular during or after the movement back into the initial position.

In a yet further refinement of the method according to the disclosure, it is provided that, after the step of the filling of the container with the product in the interior of the chamber, in particular after the movement of the filling head back into the initial position, residues of the product adhering to and/or in the spout are removed.

Finally, in an in turn yet further refinement of the method according to the disclosure, it is provided that the sterilization of the container and/or the sterilization of the interior of the chamber and/or the sterilization of the filling head and/or the sterilization of a gripper for the closure cap (said gripper removes the closure cap from the spout in the chamber before the filling process and mounts said closure cap again after the filling process) is realized by irradiation with UV radiation, in particular with pulsed UV radiation, or by irradiation with γ radiation.

There are now numerous possibilities for configuring and refining the closure device according to the disclosure, the container according to the disclosure and the method according to the disclosure.

An embodiment provides a closure device for a container for aseptically receiving a flowable product, in particular for a pouch pack, having a spout which has a product filling duct extending axially between a first end and a second end, wherein the first end forms the container-side end of the spout and the second end forms the closure-side end of the spout, having a closure cap which can be mounted onto the spout and which, in the mounted state, closes the second end of the product filling duct, wherein the closure cap is connectable in axially positively locking fashion to the spout in two axially different positions, wherein the first position of the two axially different positions is a position in which the closure cap is not fully mounted on the spout, and wherein the second position of the two axially different positions is a position in which the closure cap is fully mounted on the spout, wherein the closure cap bears sealingly against the spout in the first position and in the second position.

In various embodiments, the closure cap bears sealingly against the closure-side end of the spout, in particular at the inner side against the second end of the product filling duct, in the first position and in the second position.

In various embodiments, the axial spacing between the two positions amounts to at least 0.5 mm, such as at least 1.0 mm or at least 1.5 mm.

In various embodiments, the closure cap has a ring-shaped tamper-evident securing element which is connected in unipartite fashion to the rest of the closure cap.

In various embodiments, on the outside of the spout, there is formed a radially encircling projection whose outer diameter is greater than the inner diameter of a section of the tamper-evident securing element, wherein, in the first position, the section of the tamper-evident securing element is arranged between the closure-side end of the spout and the radially encircling projection in an axial direction, and wherein, in the second position, the section of the tamper-evident securing element is arranged between the radially encircling projection and the container-side end of the spout in the axial direction.

In various embodiments, in the first position, the tamper-evident securing element is not at least partially detached from the rest of the closure cap and/or is not destroyed.

In various embodiments, in the first position, the tamper-evident securing element is not deformed.

In various embodiments, the closure cap has, on its axial inner side, a protrusion extending in the axial direction, in particular a ring-shaped protrusion extending in the axial direction.

In various embodiments, the protrusion bears sealingly against the spout, such as against the closure-side end of the spout, in particular at the inner side against the second end of the product filling duct, in the first position and in the second position.

In various embodiments, the protrusion is connected in non-positively locking fashion to the spout, such as to the closure-side end of the spout, in particular to the inner side at the second end of the product filling duct, in the first position and in the second position.

An embodiment provides a container for aseptically receiving a flowable product, having a container body and having a spout connected to the container body wherein the container has a closure device as described herein, and the spout is a constituent part of the closure device.

An embodiment provides a method for aseptically filling a container with a product, in which method the following steps are performed: providing a container as described herein, wherein the closure cap is situated in the first position, sterilizing the container while the closure cap remains in the first position, sterilizing the interior of a chamber of a filling station, including a filling head of the filling station, transporting the sterilized container into the interior of the chamber, removing the closure cap in the interior of the chamber, filling the container with the product in the interior of the chamber, mounting the closure cap, wherein the closure cap is placed into the second position, in the interior of the chamber, and transporting the filled and fully closed container out of the chamber.

In various embodiments, after the step of the removal of the closure cap in the interior of the chamber and before the step of the filling of the container with the product in the interior of the chamber, the filling head is lowered from an initial position in the direction of the closure-side end of the spout, and in particular, a part of the filling head is lowered into the interior of the product filling duct, and wherein, after the step of the filling of the container with the product in the interior of the chamber and before the step of the mounting of the closure cap in the interior of the chamber, the filling head is moved back into the initial position.

In various embodiments, the filling head is sterilized after the step of the filling of the container with the product in the interior of the chamber, in particular during or after the movement back into the initial position.

In various embodiments, after the step of the filling of the container with the product in the interior of the chamber, in particular after the movement of the filling head back into the initial position, residues of the product adhering to and/or in the spout are removed.

In various embodiments, the sterilization of the container and/or the sterilization of the interior of the chamber and/or the sterilization of the filling head and/or the sterilization of a gripper for the closure cap is realized by irradiation with UV radiation, in particular with pulsed UV radiation, and/or by irradiation with γ radiation.

### BRIEF DESCRIPTION OF THE DRAWINGS

In the drawing:

FIGS. 1a) and b) show mutually perpendicular sectional views of a container according to the present disclosure with a closure cap in a first position relative to the spout,

FIGS. 2a) and b) show mutually perpendicular sectional views of a container according to the present disclosure with a closure cap in a second position relative to the spout, and

FIG. 3 is a schematic illustration of multiple method steps for aseptically filling a container as per FIGS. 1a) to 2b).

### DETAILED DESCRIPTION

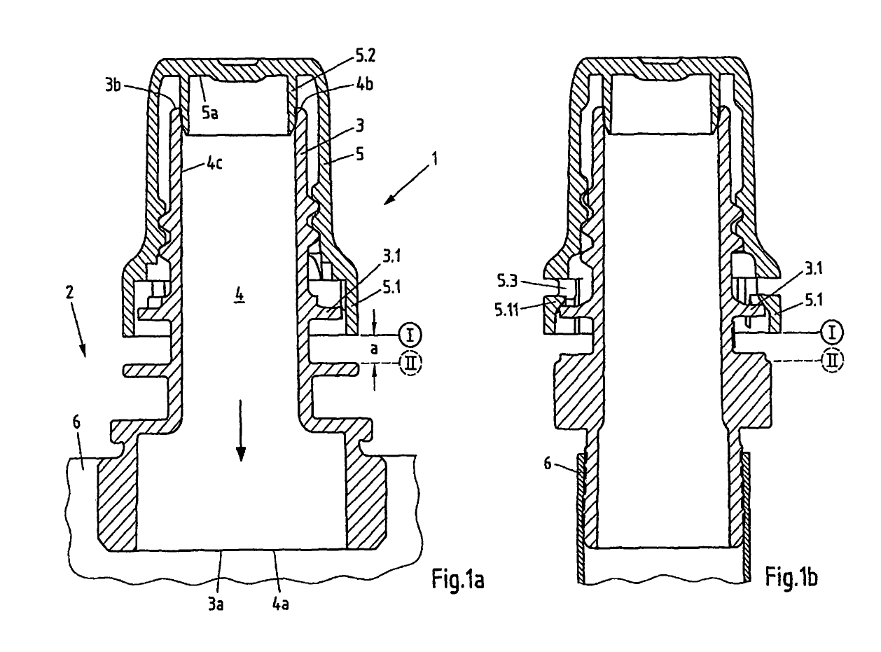

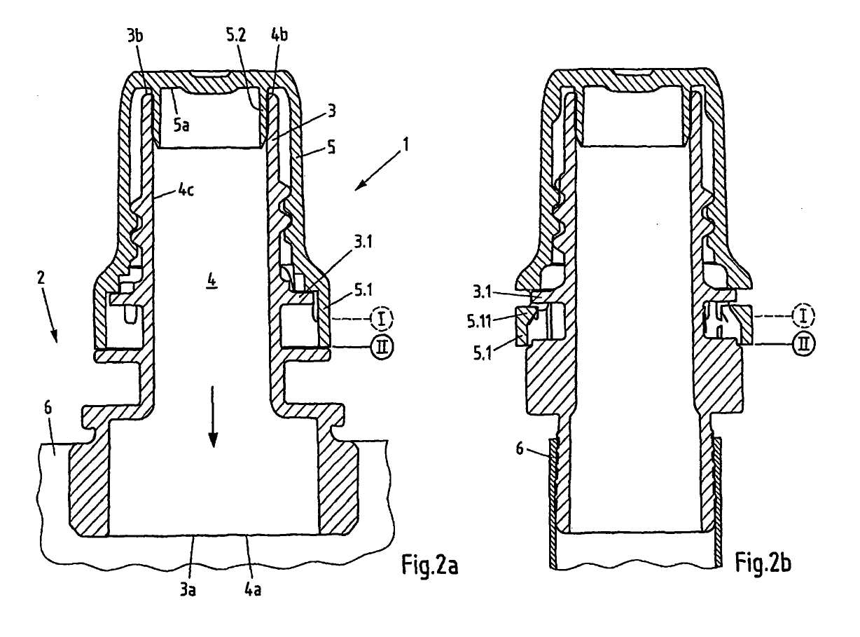

FIG. 1a) shows a container 2 having a closure device 1 for aseptically receiving a flowable product, in the form of a pouch pack, in a first section parallel to the axial direction X. FIG. 1b) shows the same container 2, with the same relative arrangement of the individual elements with respect to one another, in a section which is likewise parallel to the axial direction X but which runs perpendicular to the section in FIG. 1a). FIGS. 2a) and 2b) show sectional views corresponding to FIGS. 1a) and 1b), wherein here, the individual elements are however arranged differently relative to one another than in FIGS. 1a) and b).

The container 2 in FIGS. 1a) to 2b) has a container body 6 in the form of a flexible pouch, and a closure device 1 composed of a spout 3 and a closure cap 5, wherein the closure device 1 is welded by means of a pouch-side section 3.2 of the spout 3 to the container body or pouch 6.

According to the disclosure, a heat-sealing process or an ultrasound sealing process may be used for producing the connection between spout 3 and container body 6.

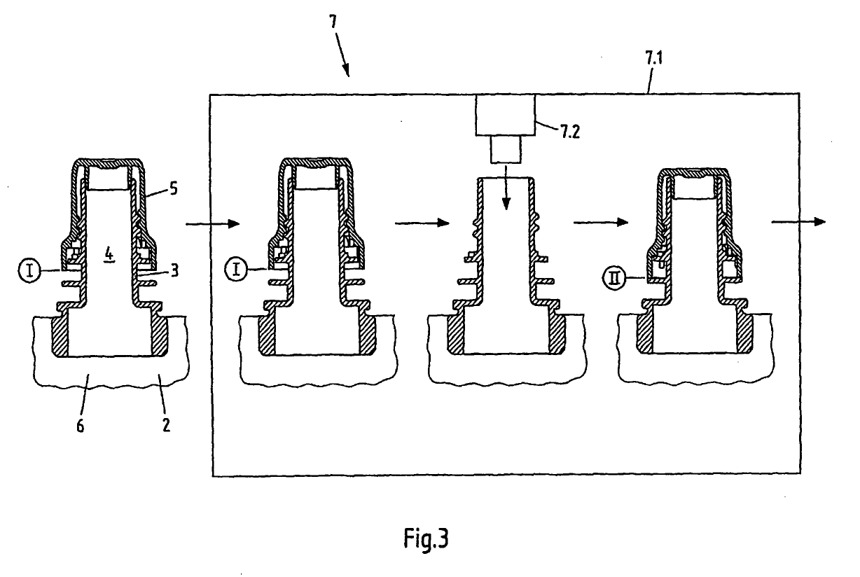

FIGS. 1a) and b) show the pouch 2, and in particular the closure device 1, in a state in which the pouch 2 can be supplied to a filling station 7 (FIG. 3). FIGS. 2a) and b) show a state after the filling of the container 2, in which state the container 2 is also supplied to the end consumer.

The closure device 1 illustrated in the figures has a unipartite spout 3 with an external thread, which spout has a product filling duct 4 which extends axially, that is to say parallel to the axial direction X, from a first end 4a to a second end 4b, and which has a cylindrical inner side 4c.

The first end 4a is the container-side or pouch-side end 3a of the spout 3, that is to say the lower end. The second end 4b is the closure-side end 3b of the spout 3, that is to say the upper end thereof.

Onto the spout 3 there is mounted a unipartite closure cap 5, which has an internal thread complementary to the thread of the spout 3. The closure cap 5 is mounted onto the spout 3 over the closure-side end 3b of the spout 3, and closes off the second end 4b of the product filling duct 4.

The closure cap 5 is situated in an axial first position I in FIGS. 1a) and b) and in an axial second position II in FIGS. 2a) and b). In both positions I and II, axial positive locking exists between closure cap 5 and spout 3 owing to the threaded connection. The axial spacing a between the two positions I and II amounts in this case to for example 1.5 mm.

In the first position I as shown in FIGS. 1a) and b), the closure cap 5 has not been fully screwed onto the spout 3, but rather can still be screwed further as far as the second position II, which is shown in FIGS. 2a) and b). According to the disclosure, in both positions I and II, the closure cap 5 bears sealingly against the spout 3, this being achieved by means of a ring-shaped protrusion 5.2 in the interior of the closure cap 5, which protrusion ensures a hermetic seal of the product receiving duct 4 with respect to the outside environment in each of the two positions I and II.

The closure cap 5 furthermore has a ring-shaped tamper-evident securing element 5.1 on the pouch-side end of the cap 5, which tamper-evident securing element is connected in unipartite fashion to the rest of the closure cap 5 by means of axial webs 5.3.

Furthermore, on the outside of the spout 3, there is formed a radially encircling projection 3.1, the outer diameter of which is greater than the inner diameter of a section 5.11 of the tamper-evident securing element 5.1. The section 5.11 has, on its underside, an oblique profile (a chamfer) in relation to the axial direction X, whereas the top side of the section 5.11 has a straight profile perpendicular to the axial direction X.

In the first position I shown in FIGS. 1a) and b), the underside of the section 5.11 bears by means of the oblique profile against the projection 3.1, wherein the section 5.11 is arranged between the closure-side end 3b of the spout 3 and the projection 3.1 in the axial direction.

If the closure cap 5 is screwed onto the spout 3 further proceeding from the position shown in FIGS. 1a) and b), the section 5.11 of the tamper-evident securing element 5.1 is guided past the projection 3.1 as the tamper-evident securing element deforms, until the closure cap 5 reaches the second position II shown in FIGS. 2a) and b). In the position II of the closure cap 5, the section 5.11 of the tamper-evident securing element 5.1 is arranged between the projection 3.1 and the container-side or pouch-side end 3a of the spout 3 in the axial direction X.

The protrusion 5.2 on the axial inner side 5a of the closure cap 5 overlaps the spout 3 in the radial direction (that is to say transversely with respect to the axial direction X) both in the first position I illustrated in FIGS. 1a) and b) and in the position II illustrated in FIGS. 2a) and b), wherein, in both positions I and II, non-positive locking is realized in the overlap region, and a hermetic seal is realized over the entire overlap region.

Before the closure cap 5 is moved into the second position II for the first time, in the first position I, the tamper-evident securing element 5.1 is not detached from the rest of the closure cap 5 and is also not destroyed or deformed. This applies in particular to the entire closure cap 5. At this point in time, or in this position, said closure cap is thus connected in axially positively locking fashion to the spout 3 in particular in deformation-free and destruction-free fashion.

The same also applies to the second position II, because said deformation of the tamper-evident securing element 5.1 as the latter is guided past the projection 3.1 from the first position Ito the second position II is only temporary. Deformation-free means that the closure cap 5 and the tamper-evident securing element 5.1 are not (elastically or plastically) deformed in relation to an unloaded state. Destruction-free means that the closure cap 5 or the tamper-evident securing element 5.1 is still situated in the original state (state after production).

FIG. 3 schematically illustrates how a container 2, such as is illustrated for example in figures 1a) to 2b), can be easily aseptically filled with a product.

Firstly, a container 2 as described above is provided, as illustrated on the left-hand side of FIG. 3. The spout 3 is fixedly connected to the container body 6 by welding. The closure cap 5 has not been fully screwed onto the spout 3, but rather is situated in the first position I. In this position I, the closure cap 5 closes off the container 2 in hermetically sealed fashion.

The container 2 thus provided is now sterilized in this state, for example by means of γ radiation.

The container 2 thus sterilized is then transported into a chamber 7.1 of a filling station 7. The interior of the chamber 7.1 has previously likewise been sterilized, for example by means of γ radiation and/or UV radiation. The filling station has a filling head 7.2 for the filling of the container 2 with a product. Said filling head 7.2 has also been sterilized before the container 2 has been transported into the chamber 7.1.

In the interior of the chamber 7.1 of the filling station 7, after the chamber 7.1 and filling head 7.2 have been sterilized, the closure cap 5 is removed or unscrewed from the spout 3. In the next step, the container 2 is filled with the product by means of the filling head 7.2, for which purpose a part of the filling head 7.2 can be lowered into the spout 3. After the filling of the container 2, the still-sterile closure cap 5 is mounted onto the spout 3 again, and this time is screwed as far as into the second position II. The container 2 is then fully closed, and the tamper-evident securing element 5.1 is situated in the final position, which, as discussed above, is arranged between the projection 3.1 and the lower end 3a of the spout 3.

As a final step (illustrated on the right-hand side in FIG. 3), the filled and fully closed container 2 is removed from the chamber 7.1 of the filling station 7 and is transported onward.

1. A closure device for a container for aseptically receiving a flowable product, comprising:
a spout which has a product filling duct extending axially between a first end and a second end, wherein the first end forms a container-side end of the spout and the second end forms a closure-side end of the spout, and
a closure cap which can be mounted onto the spout and which, in a mounted state, closes the second end of the product filling duct,
wherein the closure cap is connectable in axially positively locking fashion to the spout in two axially different positions,
wherein a first position of the two axially different positions is a position in which the closure cap is not fully mounted on the spout,
wherein a second position of the two axially different positions is a position in which the closure cap is fully mounted on the spout, and wherein the closure cap bears sealingly against the spout in the first position and in the second position.

2. The closure device as claimed in claim 1, wherein the closure cap bears sealingly against the closure-side end of the spout in the first position and in the second position.

3. The closure device as claimed in claim 1, wherein the axial spacing between the two positions amounts to at least 0.5 mm.

4. The closure device as claimed in claim 1, wherein the closure cap has a ring-shaped tamper-evident securing element which is connected in unipartite fashion to the rest of the closure cap.

5. The closure device as claimed in claim 4, wherein on the outside of the spout, there is formed a radially encircling projection whose outer diameter is greater than the inner diameter of a section of the tamper-evident securing element, wherein, in the first position, the section of the tamper-evident securing element is arranged between the closure-side end of the spout and the radially encircling projection in an axial direction, and wherein, in the second position, the section of the tamper-evident securing element is arranged between the radially encircling projection and the container-side end of the spout in the axial direction.

6. The closure device as claimed in claim 4, wherein in the first position, the tamper-evident securing element is not at least partially detached from the rest of the closure cap and/or is not destroyed.

7. The closure device as claimed in claim 4, wherein, in the first position, the tamper-evident securing element is not deformed.

8. The closure device as claimed in claim 1, wherein the closure cap has, on its axial inner side, a protrusion extending in the axial direction.

9. The closure device as claimed in claim 8, wherein the protrusion bears sealingly against the spout in the first position and in the second position.

10. The closure device as claimed in claim 8, wherein the protrusion is connected in non-positively locking fashion to the spout in the first position and in the second position.

11. A container for aseptically receiving a flowable product, comprising:
a container body, and
a spout connected to the container body, wherein the container has a closure device as claimed in claim 1, and the spout is a constituent part of the closure device.

12. A method for aseptically filling a container with a product, comprising:
providing a container as claimed in claim 8, wherein the closure cap is in the first position,
sterilizing the container while the closure cap remains in the first position,
sterilizing the interior of a chamber of a filling station, including a filling head of the filling station,
transporting the sterilized container into the interior of the chamber,
removing the closure cap in the interior of the chamber,
filling the container with the product in the interior of the chamber,
mounting the closure cap, wherein the closure cap is placed into the second position, in the interior of the chamber, and
transporting the filled and fully closed container out of the chamber.

13. The method as claimed in claim 12, wherein after the step of the removal of the closure cap in the interior of the chamber and before the step of the filling of the container with the product in the interior of the chamber, the filling head is lowered from an initial position in the direction of the closure-side end of the spout, and wherein, after the step of the filling of the container with the product in the interior of the chamber and before the step of the mounting of the closure cap in the interior of the chamber, the filling head is moved back into the initial position.

14. The method as claimed in claim 12, wherein the filling head is sterilized after the step of the filling of the container with the product in the interior of the chamber.

15. The method as claimed in claim 12, wherein after the step of the filling of the container with the product in the interior of the chamber residues of the product adhering to and/or in the spout are removed.

16. The method as claimed in claim 12, wherein the sterilization of the container and/or the sterilization of the interior of the chamber and/or the sterilization of the filling head and/or the sterilization of a gripper for the closure cap is realized by irradiation with UV radiation, and/or by irradiation with γ radiation.

17. The closure device as claimed in claim 9, wherein the protrusion bears sealingly against the closure-side end of the spout in the first position and in the second position.

18. The closure device as claimed in claim 10, wherein the protrusion is connected in non-positively locking fashion to the closure-side end of the spout in the first position and in the second position.

19. The method as claimed in claim 12, wherein after the step of the removal of the closure cap in the interior of the chamber and before the step of the filling of the container with the product in the interior of the chamber, the filling head is lowered from an initial position in the direction of the closure-side end of the spout, and a part of the filling head is lowered into the interior of the product filling duct, and wherein, after the step of the filling of the container with the product in the interior of the chamber and before the step of the mounting of the closure cap in the interior of the chamber, the filling head is moved back into the initial position.

20. The method as claimed in claim 12, wherein the filling head is sterilized after the step of the filling of the container with the product in the interior of the chamber, during or after the movement back into the initial position.
